(19) United States
(12) Patent Application Publication
(10) Pub. No.: US 2008/0179337 A1
(43) Pub. Date: Jul. 31, 2008

(54) Method for making a range of injection moulded plastics packaging products that include a bucket and lid

(76) Inventors: Jean Marc Vuillot, Cuisery (FR); Stephane Navoret, Lacrost (FR)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 11/984,665

(22) Filed: Nov. 20, 2007

(30) Foreign Application Priority Data
Nov. 20, 2006 (DK) PA 2006 01514

(51) Int. Cl. B65D 41/16; B65D 51/18; B29C 45/00; B65D 55/02

(52) U.S. Cl. 220/675; 264/513; 220/253; 220/669

(57) ABSTRACT

When practicing the present invention, the manufacturer as an initial step, and starting from a given bucket 10, selects the thickness w₃₀ of a second type lid 30 circumferential region 31 to be less than the thickness w₂₀ of a first type lid 20 circumferential region 21 whereby the circumferential flange 38 of the second type lid 30 after application on the bucket 10 is more readily manually disengaged from said locking rib 16 by an outward flexural movement of the outermost wall 37. Hence, the second type lid 30 may conveniently be formed as a “flex-off”-type lid fitting the same bucket 10 as the first type lid 20. Making lids of the second type may be by using the same injection mold as used for the first type lid 20, modified by an inlay providing for the reduced wall thickness w₃₀ and possibly for any minor differences in the design of the peripheral flanges 28, 38, such as the angle θ that the upper face A of the flange 28, 38 makes with the vertical, and the dimension λ, i.e. the width of the peripheral flange 28, 38.

The invention relates to a method for making a range of injection moulded plastics packaging products that include a bucket and a lid.

It has so far been conventional among manufacturers of such packaging products to produce two product ranges, viz. a “peel-off”-lid type packaging range and a “flex-off”-lid type packaging range. Generally, bucket and lid design for these two product ranges have evolved independently of each other, and manufacture of the buckets and lids have taken place using two different sets of injection moulds, one set for making lids and buckets of one range of differently sized “peel-off”-type packagings and another set for making lids and bucket of another range of differently sized “flex-off”-type packagings. The “flex-off”-type lids and the “peel-off”-type lids have been made on different production lines independently of each other, with their dimensions, primarily the diameter, corresponding to the size of the relevant bucket-type onto which it is to be applied.

As will be understood, this conventional way of making the packagings involve a high number of different plastics injection moulds that must be maintained and replaced at frequent intervals. The present invention is aimed at solving inter alia the problem of maintaining such a high number of injection moulds. Hence, through the invention a significant reduction in production costs may be achieved, and this by departing from conventional packaging manufacturing wisdom.

The above problem is solved by the method according to claim 1. An independent claim is also directed to a set of plastics packaging products.

The invention will now be described in further details with reference to one embodiment thereof.

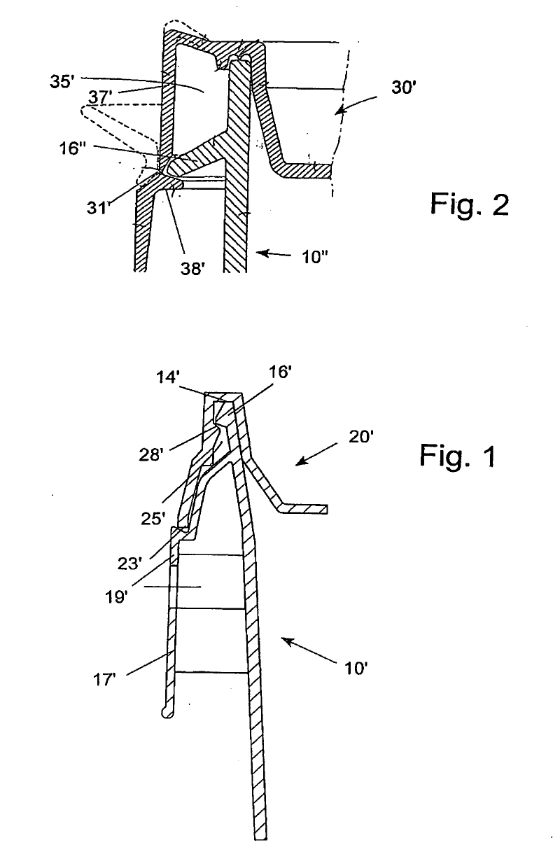

FIGS. 1 and 2 show cross-sectional views of prior art plastics lid and bucket combinations,

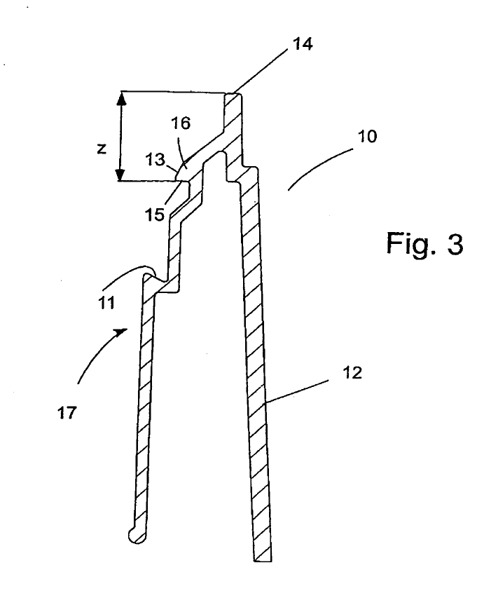

FIG. 3 shows a cross-sectional view of a bucket used according to the invention,

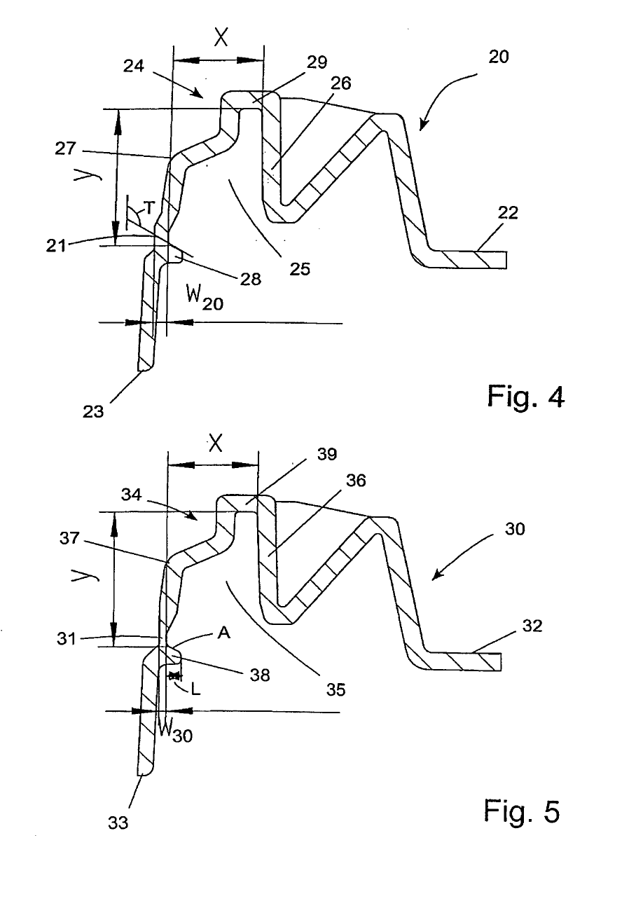

FIG. 4 shows a cross-sectional view of a first type lid used according to the invention, of the “peel-off” type,

FIG. 5 shows a cross-sectional view of a second type lid used according to the invention, of the “flex-off”-type,

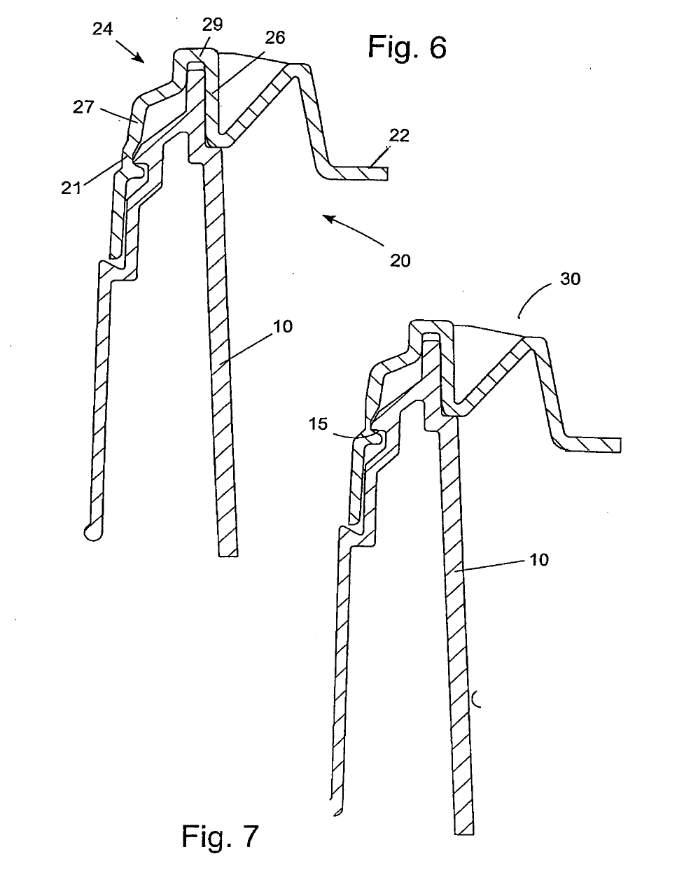

FIGS. 6 and 7 show cross-sectional views of the bucket of FIG. 3 with the lid of FIGS. 4 and 5, respectively.

FIG. 1 shows a known plastics lid and plastics bucket combination wherein the bucket 10′ has the lid 20′ applied for covering the upper end of the bucket 10′. This type of lid is often referred to as a “peel-off”-type lid reflecting the manner in which the lid is disengaged from the bucket 10′. The lid 20′ has a circumferential, downwardly open channel 25′ shaped as an inverted U and adapted to receive the rim 14′ of the bucket 10′. On application of the lid 20′ an inwardly directed circumferential flange 28′ of the lid 20′ engages in a snap-like manner a circumferential locking rib 16′ arranged on the outside of the bucket 10′ close to the rim 14′. For subsequent removal of the lid 20′ the user will tear off a finger tip width removable tearable skirt part 19′ of an external circumferential skirt 17′ on the bucket 10′ whereby after removal thereof he can apply by means of his finger tip an upwardly directed force directly onto the lower edge portion 23′ of the lid 20′. As a consequence, the flange 28′ is forced to move in a radially outward direction on the inclined lower surface of locking rib 16′ and is thus “peeled” out of engagement with the locking rib 16′ along the full circumference of the bucket 10′ by a continued upward finger tip movement. The bucket 10′ is made to specifically fit this “peel-off”-type lid 20′.

FIG. 2 shows another known plastics lid 30′ and bucket 10″ combination, as disclosed in GB 2 091 706. This type of lid 30′ is often referred to as a “flex-off”-type lid, since the outermost wall 37′ defining a downwardly open circumferential channel 35′ has a circumferential region 31′ of reduced thickness allowing the user to flex by finger tip pressure the part of the wall 3T below the reduced thickness region 31′ in an outward direction such that a circumferential lid flange 38′ is disengaged from a circumferential bucket 10″ locking rib 16″. The bucket 10″ is made to specifically fit this “flex-off”-type lid 30′.

The plastics lid and plastics bucket combinations shown in FIGS. 1 and 2 are commonly manufactured in a plastics injection moulding operation.

FIG. 3 shows the upper part of a bucket 10 for use with the invention. The bucket 10 has a bottom (not shown) integral with a circumferential wall 12 with a rim 14 and an external circumferential locking rib 16 arranged at a distance z from the rim 14 on a circumferential skirt 17 running at a distance from the wall 12. A recess 11 is preferably provided for preventing ready removal of a lid applied onto the bucket 10. The locking rib 16 is defined by an upper slanted surface 13 and a lower surface 15. Although not shown, the bucket 10 preferably has a removable skirt part, as discussed above with reference to FIG. 1, whereby, once removed, the user can apply a finger tip pressure on a lid when applied onto the bucket 10.

FIG. 4 shows a lid 20 selected in accordance with the present invention and being of a first type, and FIG. 5 shows a lid 30 selected in accordance with the invention and being of a second type.

The lids 20, 30 of FIGS. 4 and 5 are both formed with a central portion 22, 32 and a circumferential portion 24, 34 in the shape of an inverted U defining a downwardly open channel 25, 35 for receiving the rim 14 of the bucket 10 shown in FIG. 3. The channel 25 of the first type lid 20 and the channel 35 of the second type lid 30 include on an outermost wall 27, 37 thereof an inwardly directed circumferential flange 28, 38 arranged at a distance y from a bottom wall 29, 39 of the channel 25, 35 and at the distance x from an innermost wall 26, 36 of the channel 25, 35. Preferably, the value of y of the first type lid 20 is equal to the value of y of the second type lid 30 and the value of x of the first type lid 20 is equal to the value of x of the second type lid 30, as in the shown embodiment.

The outermost wall 27, 37 of both lids 20, 30 have a thickness w₂₀, w₃₀ along a circumferential region 21, 31 adjacent the circumferential flange 28, 38, and the Inwardly directed circumferential flange 28 of the first type lid 20 and the inwardly directed circumferential flange 38 of the second type lid 30 are adapted for engaging the locking rib 16 of the bucket 10 when either lid 20, 30 is applied onto the bucket 10, in order to secure the lid 20, 30 to the bucket 10.

In accordance with the invention, common to both lids 20, 30 is that they have essentially the same overall dimensions to fit a selected size of a bucket as shown in FIG. 3 and primarily differ from each other as will be discussed below. Pairs of lids 20, 30 fitting a particular size bucket may be made in accordance with the invention. A packaging products range may then be formed where one pair and its corresponding bucket typically and preferably will differ from the other pair and its corresponding bucket by being scaled up.

When practicing the present invention, the manufacturer as an initial step, and starting from a given bucket 10, selects the thickness w₃₀ of the second type lid 30 circumferential region 31 to be less than the thickness w₂₀ of the first type lid 20 circumferential region 21 whereby the circumferential flange 38 of the second type lid 30 after application on the bucket 10 is more readily manually disengaged from said locking rib 16 by an outward flexural movement of a part of the outermost wall 37, as indicated schematically in FIG. 2. Hence, the second type lid 30 may conveniently be formed as a “flex-off”-type lid fitting the same bucket 10 as the first type lid 20. Making lids of the second type may be by using the same injection mold as used for the first type lid 20, modified by an inlay providing for the reduced wall thickness w₃₀ and possibly for any minor differences in the design of the peripheral flanges 28, 38, such as the angle T that the upper face A of the flange 28, 38 makes with the vertical, and the dimension L, i.e. the width of the peripheral flange 28, 38.

FIG. 6 shows the first type lid 20 applied on the bucket 10, and FIG. 7 shows the second type lid 30 applied on the bucket 10. The lids 20, 30 are secured to the bucket 10 through the peripheral flange 28, 38 engaging the lower surface 15 of the locking rib 16.

The bucket 10 shown in FIGS. 3, 6 and 7 has a given height, and a given diameter if round or a given width if square or rectangular. The “flex-off”-type lid 30 applied on the bucket 10 as shown in FIG. 7 has a reduced width w₃₀, and may have the angle T reduced slightly, such as in the order of 5°-15°, preferably 5°-10°, and may also have its dimension L increased slightly, such as by 5%-10%, as compared to the “peel-off”-type lid shown in FIG. 6. Such differences may be desirable depending on the ease with which the user must be able to remove the lid by an upwardly directed force after removal of a part of the skirt, as discussed in relation to FIGS. 1 and 2. One may, of course, envisage the same lids 20, 30 applied on another container 10 that has the same diameter or width as the one shown in FIGS. 6 and 7, but a different height; such a combination would then make use of the same pair of lids 20, 30.

Its is noted that the aforementioned principles may also be drawn on in relation to buckets that differ slightly as regards the design of parts of the bucket that have no function in retaining the lid. Hence, it is quite possible to design those parts of the bucket that are not shown in FIGS. 6 and 7 differently; for instance, bucket fitting the same pair of lids may have differently shaped bottom areas.

1. A method of making a range of molded plastics packaging products including a bucket (10) having a bottom, a circumferential wall (12), a rim (14) and an external circumferential locking rib (16) arranged at a distance (z) from said rim (14), said method including the steps of:
selecting a bucket (10) and forming a plurality of said bucket (10),
forming a plurality of a first type lid (20) fitting said bucket (10), and
forming a plurality of a second type lid (30) fitting said bucket (10),
each of said lids (20, 30) having a central portion (22, 32) and a circumferential portion (24, 34) in the shape of an inverted U defining a channel (25, 35) for receiving said rim (14) of said bucket (10),
said channel (25) of said first type lid (20) and said channel (35) of said second type lid (30) being defined by an outermost wall (27, 37) and an innermost wall (26, 36), an inwardly directed circumferential flange (28, 38) being formed on said outermost wall (27, 37) at a distance from a bottom wall (29, 39) of said channel (25, 35) and at a distance from said innermost wall (26,36),
said outermost wall (27, 37) of said lids (20, 30) having a thickness 20 along a circumferential region (21, 31) adjacent said circumferential flange (28,38),
said inwardly directed circumferential flange (28) of said first type lid (20) and said inwardly directed circumferential flange (38) of said second type lid (30) being adapted for engaging said locking rib (16) of said bucket (10) upon said lid (20, 30) being applied to said bucket (10), to thereby secure said lid (20, 30) to said bucket (10),
said method comprising the initial step of selecting said thickness (W₃₀) of said second type lid (30) circumferential region (31) to be less than said thickness (W₂₀) of said first type lid (20) circumferential region (21) whereby 30 said circumferential flange (38) of said second type lid (30) after application on said bucket (10) may be more readily manually disengaged from said locking rib (16) by an outward flexural movement of said outermost wall (37).

2. A method according to claim 1, wherein the inwardly directed flange (28) of said first type lid (20) is arranged at substantially the same distance (y) from said bottom wall (29, 39) as the inwardly directed flange (38) of said second type lid (30).

3. A method according to claim 1, wherein the inwardly directed flange (28) of said first type lid (20) is arranged at substantially the same distance (x) from said innermost wall (26, 36) as the inwardly directed flange (38) of said second type lid (30).

4. A method according claim 1, wherein said first type lid (20) and said second type lid (30) are essentially identical but for the thickness of said outermost wall circumferential region (21, 31).

5. A method according to claim 1, wherein said first type lid (20) and said second type lid (30) are essentially identical but for the thickness of said outermost wall circumferential region (21, 31), the angle T that an upper face A of the flange 28, 38 makes with the vertical, and possibly also the width L of the peripheral flange 28,38.

6. A method according to claim 1, wherein said plurality of said bucket (10) is manufactured in a first production line, and wherein said plurality of said first type lid (20) and said plurality of said second type lid (30) are manufactured in a second production line.

7. A method according to claim 1, wherein said plurality of said bucket (10) is manufactured in a first production line, and wherein said plurality of said first type lid (20) is manufactured in a second production line and said plurality of said second type lid (30) is manufactured in a third production line.

8. A set of molded plastics packaging products including:
a bucket (10) having a bottom, a circumferential wall (12), a rim (14) and an external circumferential locking rib arranged at a distance (z) from said rim,
a plurality of a first type lid (20) for said bucket (10), and
a plurality of a second type lid (30) for said bucket (10),
each of said lids (20, 30) having a central portion (22, 32) and a circumferential portion (24, 34) in the shape of an inverted U defining a channel (25, 35) for receiving said rim (14) of said bucket (10),
said channel (25) of said first type lid (20) and said channel (35) of said second type lid (30) being defined by an innermost wall (26, 36) and an outermost wall (27, 37), an inwardly directed circumferential flange (28, 38) being formed on said outermost wall (27, 37) at a distance from a bottom wall (29, 39) of said channel (25, 35) and at a distance from said innermost wall (26, 36),
said outermost wall (27, 37) of said lids (20, 30) having a thickness along a circumferential region (21, 31) adjacent said circumferential flange (28,38),
said inwardly directed circumferential flange (28) of said first type lid (20) and said inwardly directed circumferential flange (38) of said second type lid (30) being adapted for engaging said locking rib (16) of said bucket (10) upon said lid (20, 30) being applied to said bucket (10), to thereby secure said lid (20, 30) to said bucket (10),
said thickness (W₃₀) of said second type lid (30) circumferential region (31) being less than said thickness (W20) of said first type lid (20) circumferential region (21) whereby said circumferential flange (38) of said second type lid (30) after application to said bucket (10) may be more readily manually disengaged from said locking rib (16) by an outward flexural movement of a part of said outermost wall (37).

9. A set according to claim 8, wherein the inwardly directed flange (28) of said first type lid (20) is arranged at substantially the same distance (y) from said bottom wall (29) as the inwardly directed flange (38) of said second type lid (30).

10. A set according to claim 8, wherein the inwardly directed flange (28) of said first type lid (20) is arranged at substantially the same distance (x) from said innermost wall (26, 36) as the inwardly directed flange (38) of said second type lid (30).

11. A set according to any claim 8, wherein said first type lid (20) and said second type lid (30) are identical but for the thickness of said outermost wall circumferential region (21, 31).

12. A set according to claim 8, wherein said first type lid (20) and said second type lid (30) are essentially identical but for the thickness of said outermost wall circumferential region (21, 31), the angle T that an upper face A of the flange (28, 38) makes with the vertical, and also the width L of the peripheral flange (28, 38).

13. A set according to claim 8, wherein said bucket (10) includes an external circumferential skirt (17) with a removable portion (19) below said locking rib (16), said portion allowing a user to apply a finger on an edge portion (23, 33) of said outermost wall (27, 37) of said lid (20, 30) when applied to said bucket (10), for manipulation thereof.
